(19) United States
(12) Patent Application Publication
(10) Pub. No.: US 2015/0161042 A1
(43) Pub. Date: Jun. 11, 2015

(54) MEMORY MANAGEMENT METHOD, MEMORY CONTROLLING CIRCUIT UNIT, AND MEMORY STORAGE DEVICE

(71) Applicant: PHISON ELECTRONICS CORP., Miaoli (TW)

(72) Inventors: Ming-Jen Liang, Hsinchu City (TW); Kheng-Chong Tan, Miaoli (TW)

(73) Assignee: PHISON ELECTRONICS CORP., Miaoli (TW)

(21) Appl. No.: 14/160,578

(22) Filed: Jan. 22, 2014

(30) Foreign Application Priority Data
Dec. 9, 2013 (TW) 102145210

(51) Int. Cl. G06F 12/02

(52) U.S. Cl. CPC G06F 12/0253; G06F 12/0246; G06F 2212/702; G06F 2212/7201; G06F 2212/7205

(57) ABSTRACT

A memory management method, a memory controlling circuit unit and a memory storage device are provided. The method includes: configuring a plurality of super physical erasing units, wherein each of the super physical erasing units includes at least two physical erasing units. A first super physical erasing unit includes a first physical erasing unit and a second physical erasing unit that belong to different operation units. The first physical erasing unit and the second physical erasing unit store different parts of first data. The physical erasing unit storing least valid data from each operation unit is selected for executing a garbage collection procedure. Accordingly, an efficiency of the garbage collection procedure is increased.

### CROSS-REFERENCE TO RELATED APPLICATION

This application claims the priority benefit of Taiwan application serial no. 102145210, filed on Dec. 9, 2013. The entirety of the above-mentioned patent application is hereby incorporated by reference herein and made a part of this specification.

### BACKGROUND

1. Technical Field

The invention relates to a memory management method, and more particularly, relates to a memory management method, a memory controlling circuit unit and a memory storage device for a rewritable non-volatile memory module.

2. Description of Related Art

The markets of digital cameras, cellular phones, and MP3 players have expanded rapidly in recent years, resulting in escalated demand for storage media by consumers. The characteristics of data non-volatility, low power consumption, and compact size make a rewritable non-volatile memory module (e.g., flash memory) ideal to be built in the portable multi-media devices as cited above.

Generally, the rewritable non-volatile memory module is controlled by a memory controlling circuit unit. The memory controlling circuit unit may receive data from a host system, and write the data into the rewritable non-volatile memory module. In certain configurations, the memory controlling circuit unit may group a plurality of physical erasing units into one super physical erasing unit, and the memory controlling circuit unit may program the physical erasing units within the same super physical erasing unit alternately or simultaneously. Accordingly, when a sequential data is issued from the host system, a speed for writing data into the rewritable non-volatile memory module may be increased. However, how to effectively complete a garbage collection procedure while grouping the physical erasing units into the same super physical erasing unit is one of the major subjects for person skilled in the art.

Nothing herein should be construed as an admission of knowledge in the prior art of any portion of the present invention. Furthermore, citation or identification of any document in this application is not an admission that such document is available as prior art to the present invention, or that any reference forms a part of the common general knowledge in the art.

### SUMMARY

The invention is directed to a memory management method, a memory controlling circuit unit and a memory storage device, capable of effectively executing a garbage collection procedure.

A memory management method is provided according to an exemplary embodiment of the invention, which is used for a rewritable non-volatile memory module. The rewritable non-volatile memory module includes a plurality of physical erasing units, and each of the physical erasing units belongs to one of a plurality of operation units. The memory management method includes: configuring a plurality of super physical erasing units, wherein each of the super physical erasing units includes at least two physical erasing units. The super physical erasing units include a first super physical erasing unit. The first super physical erasing unit includes a first physical erasing unit and a second physical erasing unit. The first physical erasing unit belongs to a first operation unit, and the second physical erasing unit belongs to a second operation unit. A first part of first data is stored in the first physical erasing unit, and a second part of the first data is stored in the second physical erasing unit. Said method further includes: selecting, from among the physical erasing units storing valid data in the first operation unit, a third physical erasing unit storing least valid data; selecting the second physical erasing unit from the second operation unit; copying the valid data in the third physical erasing unit and the valid data in the second physical erasing unit into at least one fourth physical erasing unit; and erasing the third physical erasing unit and the second physical erasing unit.

A memory storage device is provided according to exemplary embodiments of the invention, which includes a connection interface unit, the rewritable non-volatile memory module described above and a memory controlling circuit unit. The connection interface unit is configured to couple to a host system. The memory controlling circuit unit is coupled to the connection interface unit and the rewritable non-volatile memory module, and configured to configure a plurality of super physical erasing units. Therein, each of the super physical erasing units includes at least two physical erasing units. The super physical erasing units include a first super physical erasing unit. The first super physical erasing unit includes a first physical erasing unit and a second physical erasing unit. The first physical erasing unit belongs to a first operation unit, and the second physical erasing unit belongs to a second operation unit. A first part of first data is stored in the first physical erasing unit, and a second part of the first data is stored in the second physical erasing unit. The memory controlling circuit unit is also configured to select, from among the physical erasing units storing valid data in the first operation unit, a third physical erasing unit storing least valid data, and select the second physical erasing unit from the second operation unit. The memory controlling circuit unit is further configured to copy the valid data in the third physical erasing unit and the valid data in the second physical erasing unit into at least one fourth physical erasing unit, and erase the third physical erasing unit and the second physical erasing unit.

A memory controlling circuit unit is provided according to an exemplary embodiment of the invention, and configured to control the rewritable non-volatile memory module described above. The memory controlling circuit unit includes a host interface, a memory interface and a memory management circuit. The host interface is configured to couple to a host system. The memory interface is configured to couple to the rewritable non-volatile memory module. The memory management circuit is coupled to the host interface and the memory interface, and configured to configure a plurality of super physical erasing units. Therein, each of the super physical erasing units includes at least two physical erasing units. The super physical erasing units include a first super physical erasing unit. The first super physical erasing unit includes a first physical erasing unit and a second physical erasing unit. The first physical erasing unit belongs to a first operation unit, and the second physical erasing unit belongs to a second operation unit. A first part of first data is stored in the first physical erasing unit, and a second part of the first data is stored in the second physical erasing unit. The memory management circuit is also configured to select, from among the physical erasing units storing valid data in the first operation unit, a third physical erasing unit storing least valid data, and select the second physical erasing unit from the second operation unit. The memory management circuit is further configured to copy the valid data in the third physical erasing unit and the valid data in the second physical erasing unit into at least one fourth physical erasing unit among the physical erasing units, and erase the third physical erasing unit and the second physical erasing unit.

In view of above, the memory management method, the memory controlling circuit unit and the memory storage device as proposed according to the exemplary embodiments of the invention are capable of executing the garbage collection procedure to the physical erasing units in different super physical erasing units, such that the valid data to be moved may be reduced.

To make the above features and advantages of the disclosure more comprehensible, several embodiments accompanied with drawings are described in detail as follows.

It should be understood, however, that this Summary may not contain all of the aspects and embodiments of the present invention, is not meant to be limiting or restrictive in any manner, and that the invention as disclosed herein is and will be understood by those of ordinary skill in the art to encompass obvious improvements and modifications thereto.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A illustrates a host system and a memory storage device according to an exemplary embodiment.

FIG. 1B is a schematic diagram illustrating a computer, an input/output device and a memory storage device according to an exemplary embodiment.

FIG. 1C is a schematic diagram illustrating a host system and a memory storage device according to an exemplary embodiment.

FIG. 2 is a schematic block diagram illustrating the memory storage device depicted in FIG. 1A.

FIG. 3 is a schematic block diagram illustrating a memory controlling circuit unit according to an exemplary embodiment.

FIG. 4 is a schematic diagram illustrating an example for a management under a memory storage device according to an exemplary embodiment.

FIG. 5 illustrates a schematic diagram of data writing according to an exemplary embodiment.

FIG. 6A and FIG. 6B are schematic diagrams illustrating a garbage collection procedure according to an exemplary embodiment.

FIG. 7A and FIG. 7B are a flowchart illustrating a memory management method according to an exemplary embodiment.

FIG. 8A illustrates a schematic diagram illustrating a super physical erasing unit according to an exemplary embodiment.

FIG. 8B is schematic diagram illustrating a garbage collection procedure according to an exemplary embodiment.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Embodiments of the present invention may comprise any one or more of the novel features described herein, including in the Detailed Description, and/or shown in the drawings. As used herein, “at least one”, “one or more”, and “and/or” are open-ended expressions that are both conjunctive and disjunctive in operation. For example, each of the expressions “at least on of A,B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

It is to be noted that the term “a” or “an” entity refers to one or more of that entity. As such, the terms “a” (or “an”), “one or more” and “at least one” can be used interchangeably herein.

### First Exemplary Embodiment

Generally, a memory storage device (also known as a memory storage system) includes a rewritable non-volatile memory module and a controller (also known as a control circuit). The memory storage device is usually configured together with a host system so that the host system may write data to or read data from the memory storage device.

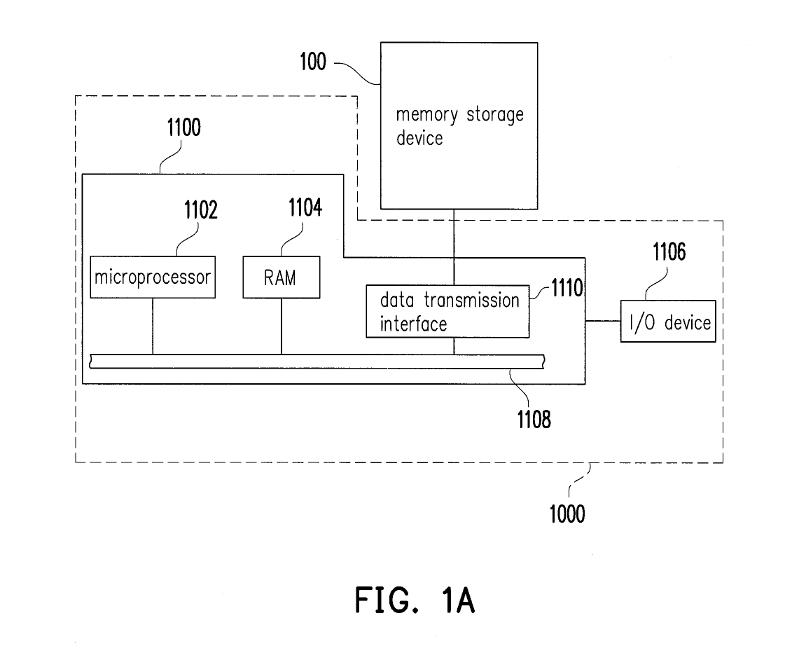

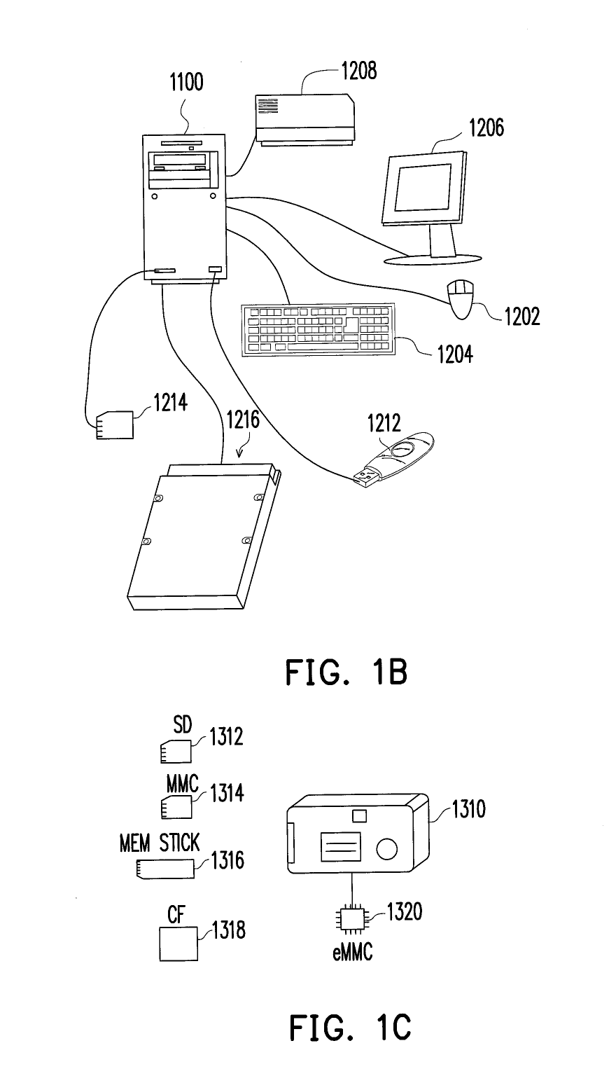

FIG. 1A illustrates a host system and a memory storage device according to an exemplary embodiment. FIG. 1B is a schematic diagram illustrating a computer, an input/output device and a memory storage device according to an exemplary embodiment. FIG. 1C is a schematic diagram illustrating a host system and a memory storage device according to an exemplary embodiment.

Referring to FIG. 1A, a host system 1000 includes a computer 1100 and an input/output (I/O) device 1106. The computer 1100 includes a microprocessor 1102, a random access memory (RAM) 1104, a system bus 1108, and a data transmission interface 1110. The I/O device 1106 includes a mouse 1202, a keyboard 1204, a display 1206 and a printer 1208 as shown in FIG. 1B. It should be understood that the devices illustrated in FIG. 1B are not intended to limit the I/O device 1106, and the I/O device 1106 may further include other devices.

In the embodiment of the invention, the memory storage device 100 is coupled to other devices of the host system 1000 through the data transmission interface 1110. By using the microprocessor 1102, the random access memory (RAM) 1104 and the Input/Output (I/O) device 1106, data may be written into the memory storage device 100 or may be read from the memory storage device 100. For example, the memory storage device 100 may be a rewritable non-volatile memory storage device such as a flash drive 1212, a memory card 1214, or a solid state drive (SSD) 1216 as shown in FIG. 1B.

Generally, the host system 1000 may substantially be any system capable of storing data with the memory storage device 100. Although the host system 1000 is described as a computer system in the present exemplary embodiment, in another exemplary embodiment of the invention, the host system 1000 may be a digital camera, a video camera, a telecommunication device, an audio player, or a video player. For example, if the host system is a digital camera (video camera) 1310, the rewritable non-volatile memory storage device may be a SD card 1312, a MMC card 1314, a memory stick 1316, a CF card 1318 or an embedded storage device 1320 (as shown in FIG. 1C). The embedded storage device 1320 includes an embedded MMC (eMMC). It should be mentioned that the eMMC is directly coupled to a substrate of the host system.

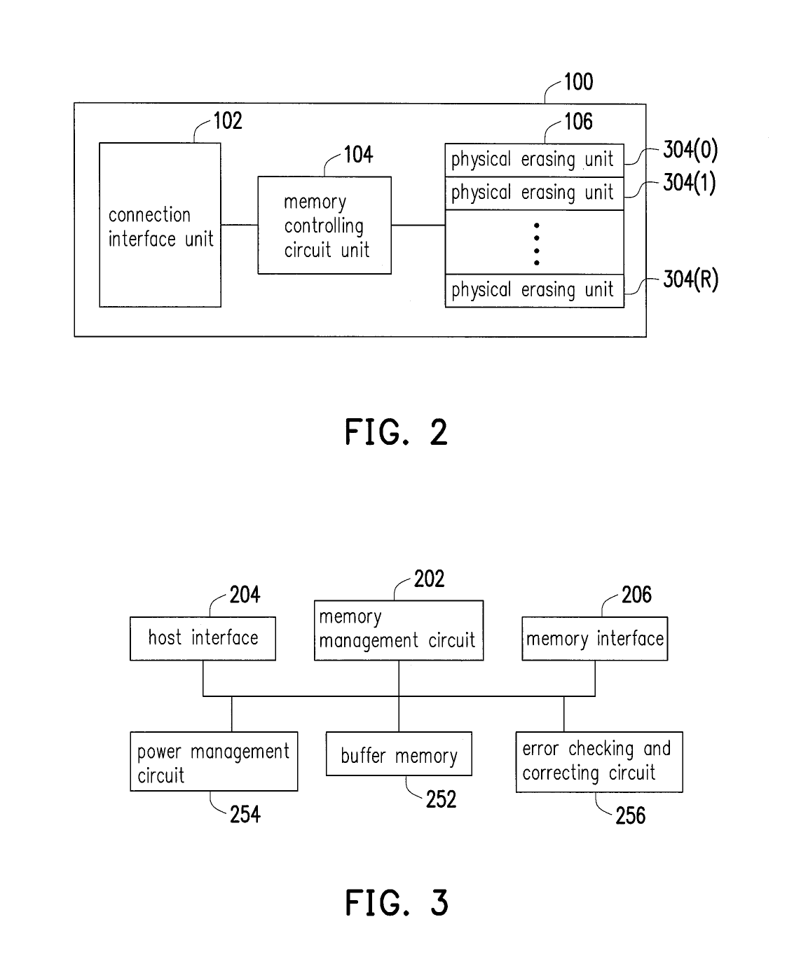

FIG. 2 is a schematic block diagram illustrating the memory storage device depicted in FIG. 1A.

Referring to FIG. 2, the memory storage device 100 includes a connection interface unit 102, a memory controlling circuit unit 104 and a rewritable non-volatile memory storage module 106.

In the present exemplary embodiment, the connection interface unit 102 is compatible with a serial advanced technology attachment (SATA) standard. However, the invention is not limited thereto, and the connection interface unit 102 may also be compatible with a Parallel Advanced Technology Attachment (PATA) standard, an Institute of Electrical and Electronic Engineers (IEEE) 1394 standard, a peripheral component interconnect (PCI) Express interface standard, a universal serial bus (USB) standard, a secure digital (SD) interface standard, a Ultra High Speed-I (UHS-I) interface standard, a Ultra High Speed-II (UHS-II) interface standard, a memory sick (MS) interface standard, a multi media card (MMC) interface standard, an embedded MMC (eMMC) interface standard, a Universal Flash Storage (UFS) interface standard, a compact flash (CF) interface standard, an integrated device electronics (IDE) interface standard or other suitable standards. The connection interface unit 102 and the memory controlling circuit unit 104 may be packaged into one chip, or the connection interface unit 102 is distributed outside of a chip containing the memory controlling circuit unit 104.

The memory controlling circuit unit 104 is configured to execute a plurality of logic gates or control commands which are implemented in a hardware form or in a firmware form, so as to perform operations of writing, reading or erasing data in the rewritable non-volatile memory storage module 106 according to the commands of the host system 1000.

The rewritable non-volatile memory storage module 106 is coupled to the memory controlling circuit unit 104 and configured to store data written from the host system 1000. The rewritable non-volatile memory storage module 106 has multiple physical erasing units 304(0) to 304(R). For example, the physical erasing units 304(0) to 304(R) may belong to the same memory die or belong to different memory dies. Each physical erasing unit has a plurality of physical programming units, and the physical programming units of the same physical erasing unit may be written separately and erased simultaneously. For example, each physical erasing unit is composed by 128 physical programming units. Nevertheless, it should be understood that the invention is not limited thereto. Each physical erasing unit is composed by 64 physical programming units, 256 physical programming units or any amount of the physical programming units.

More specifically, each of the physical programming units includes a plurality of word lines and a plurality of bit lines, and a memory cell is disposed at an intersection of each of the word lines and each of the data lines. Each memory cell can store one or more bits. All of the memory cells in the same physical erasing unit are erased together. In the present exemplary embodiment, the physical erasing unit is a minimum unit for erasing. Namely, each physical erasing unit contains the least number of memory cells to be erased together. For instance, the physical erasing unit is a physical block. Furthermore, the memory cells on the same word line can be grouped into one or more of the physical programming units. In case each of the memory cells may store two or more bits, the physical programming units on the same word line may be classified into a lower physical programming unit and an upper physical programming unit. Generally, a writing speed of the lower physical programming unit is faster than a writing speed of the upper physical programming unit. In the present exemplary embodiment, the physical programming unit is a minimum unit for programming. That is, the physical programming unit is the minimum unit for writing data. For example, the physical programming unit is a physical page or a physical sector. In case the physical programming unit is the physical page, each physical programming unit usually includes a data bit area and a redundancy bit area. The data bit area has multiple physical sectors configured to store user data, and the redundant bit area is configured to store system data (e.g., an error correcting code). In the present exemplary embodiment, each of the data bit areas contains 8 physical sectors, and a size of each physical sector is 512-byte (B). However, in other exemplary embodiments, the data bit area may also include 16, 32, or more or less of the physical sectors, and amount and sizes of the physical sectors are not limited in the invention.

Each of the physical erasing units 304(0) to 304(C) belongs to one of a plurality of operation units. The physical erasing units belonging to different operation units may be programmed alternately or simultaneously. For instance, the operation unit may be a channel, a chip or a plane. More specifically, in an exemplary embodiment, the memory storage device 100 includes a plurality of channels, and the memory controlling circuit unit 104 accesses different parts of the physical erasing units 304(0) to 304(R) through different channels. The physical erasing units on the different channels may operate independently. For instance, while the memory controlling circuit unit 104 is executing a writing operation on the physical erasing units on one channel, the memory controlling circuit unit 104 may simultaneously execute a reading operation or other operations on the physical erasing units on another channel. In the memory storage device 100, the physical erasing units in the same channel may belong to different chips. In an exemplary embodiment, the physical erasing units belonging to different chips may also belong to different interleaving. After the physical erasing units in a particular chip are programmed, the memory control circuit unit 104 may continue to program the physical erasing units in the next chip without waiting for a ready signal replied from the particular chip. In the rewritable non-volatile memory module 106, the physical erasing units in the same interleave may also belong to different planes. In the same interleave, the physical erasing units belonging to different planes may be simultaneously programmed according to the same writing command.

In the present exemplary embodiment, the memory storage device 100 includes one channel and two chips, and each of the two chips includes two planes, but the invention is not limited thereto. In another exemplary embodiment, the memory storage device 100 may also include n channels, m interleaves, and k planes. Therein, n, m and k are positive integers, and one of the positive integers is greater than 1 (i.e., the memory storage device 100 includes a plurality of operation units). However, values of the positive integers n, m and k are not particularly limited in the invention.

In the present exemplary embodiment, the rewritable non-volatile memory module 106 is a Multi Level Cell (MLC) NAND flash memory module which stores at least 2 bits in one cell. The rewritable non-volatile memory module 106 may also be a Single Level Cell (SLC) NAND flash memory module, a Trinary Level Cell (TLC) NAND flash memory module, other flash memory modules or any memory module having the same features.

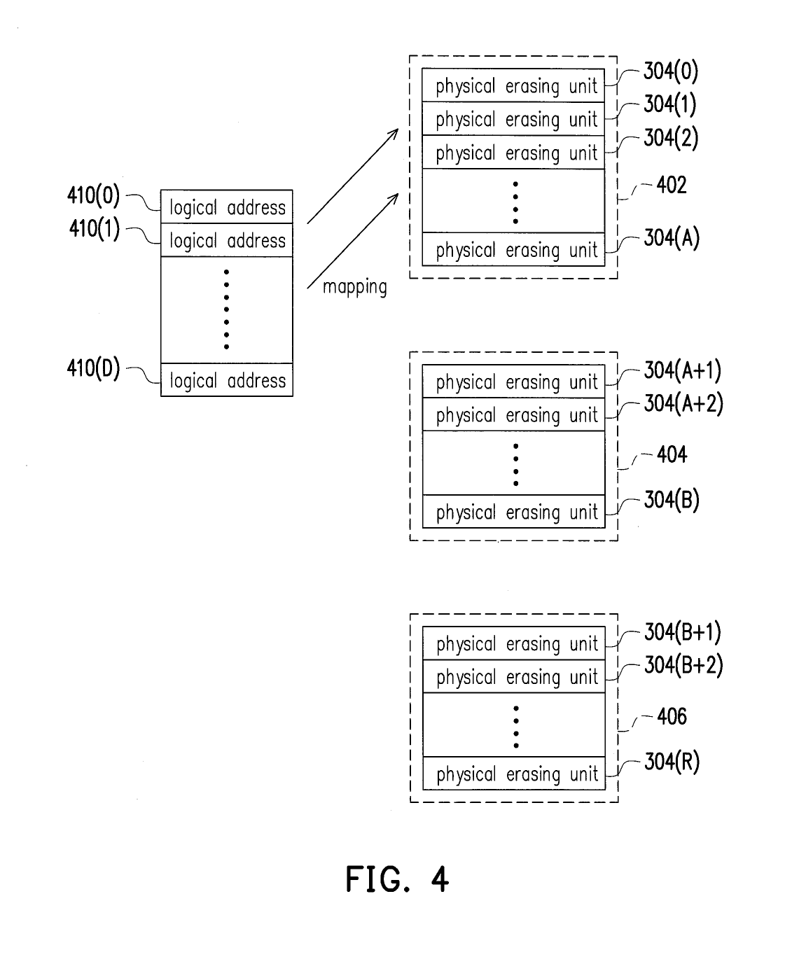

FIG. 3 is a schematic block diagram illustrating a memory controlling circuit unit according to an exemplary embodiment.

Referring to FIG. 3, the memory control circuit unit 104 includes a memory management circuit 202, a host interface 204 and a memory interface 206.

The memory management circuit 202 is configured to control overall operations of the memory control circuit unit 104. Specifically, the memory management circuit 202 has a plurality of control commands. When the memory storage device 100 operates, the control commands are executed to perform various operations such as data writing, data reading and data erasing. Operations of the memory management circuit 202 are similar to the operations of the memory controlling circuit unit 104, thus related description is omitted hereinafter.

In the present exemplary embodiment, the control commands of the memory management circuit 202 are implemented in a form of a firmware. For instance, the memory management circuit 202 has a microprocessor unit (not illustrated) and a ROM (not illustrated), and the control commands are burned into the ROM. When the memory storage device 100 operates, the control commands are executed by the microprocessor to perform operations of writing, reading or erasing data.

In another exemplary embodiment of the invention, the control commands of the memory management circuit 202 may also be stored as program codes in a specific area (for example, the system area in a memory exclusively used for storing system data) of the rewritable non-volatile memory module 106. In addition, the memory management circuit 202 has a microprocessor unit (not illustrated), a ROM (not illustrated) and a RAM (not illustrated). More particularly, the ROM has a boot code, which is executed by the microprocessor unit to load the control commands stored in the rewritable non-volatile memory module 106 to the RAM of the memory management circuit 202 when the memory controlling circuit unit 104 is enabled. Next, the control commands are executed by the microprocessor unit to perform operations of writing, reading or erasing data.

Further, in another exemplary embodiment of the invention, the control commands of the memory management circuit 202 may also be implemented in a form of hardware. For example, the memory management circuit 220 includes a microcontroller, a memory writing unit, a memory reading unit, a memory erasing unit and a data processing unit. The memory management unit, the memory writing unit, the memory reading unit, the memory erasing unit and the data processing unit are coupled to the microprocessor. The memory management unit is configured to manage the physical erasing units of the rewritable non-volatile memory module 106; the memory writing unit is configured to issue a writing command to the rewritable non-volatile memory module 106 in order to write data to the rewritable non-volatile memory module; the memory reading unit is configured to issue a read command to the rewritable non-volatile memory module 106 in order to read data from the rewritable non-volatile memory module 106; the memory erasing unit is configured to issue an erase command to the rewritable non-volatile memory module 106 in order to erase data from the rewritable non-volatile memory module 106; the data processing unit is configured to process both the data to be written to the rewritable non-volatile memory module 106 and the data to be read from the rewritable non-volatile memory module 106.

The host interface 204 is coupled to the memory management circuit 202 and configured to receive and identify commands and data sent from the host system 1000. Namely, the commands and data sent from the host system 1000 are passed to the memory management circuit 202 through the host interface 204. In the present exemplary embodiment, the host interface 204 is compatible to a SATA standard. However, it should be understood that the present invention is not limited thereto, and the host interface 204 may also be compatible with a PATA standard, an IEEE 1394 standard, a PCI Express standard, a USB standard, a SD standard, a UHS-I standard, a UHS-II standard, a MS standard, a MMC standard, a eMMC standard, a UFS standard, a CF standard, an IDE standard, or other suitable standards for data transmission.

The memory interface 206 is coupled to the memory management circuit 202 and configured to access the rewritable non-volatile memory module 106. That is, data to be written to the rewritable non-volatile memory module 106 is converted to a format acceptable to the rewritable non-volatile memory module 106 through the memory interface 206.

In an exemplary embodiment of the invention, the memory control circuit unit 104 further includes a buffer memory 252, a power management circuit 254 and an error checking and correcting circuit 256.

The buffer memory 252 is coupled to the memory management circuit 202 and configured to temporarily store data and commands from the host system 1000 or data from the rewritable non-volatile memory module 106.

The power management unit 254 is coupled to the memory management circuit 202 and configured to control a power of the memory storage device 100.

The error checking and correcting circuit 256 is coupled to the memory management circuit 202 and configured to perform an error checking and correcting process to ensure the correctness of data. Specifically, when the memory management circuit 202 receives a writing command from the host system 1000, the error checking and correcting circuit 256 generates an error correcting code (ECC) for data corresponding to the writing command, and the memory management circuit 202 writes data and the ECC corresponding to the writing command to the rewritable non-volatile memory module 106. Subsequently, when the memory management circuit 202 reads the data from the rewritable non-volatile memory module 106, the ECC corresponding to the data is also read, and the error checking and correcting circuit 256 may execute the error checking and correcting procedure for the read data according to the ECC.

FIG. 4 is a schematic diagram illustrating an example for a management under a memory storage device according to an exemplary embodiment.

It should be understood that terms, such as “select”, “divide”, “associate” and so forth, are logical concepts which describe operations in the physical erasing units of the rewritable non-volatile memory module 106. That is, the physical erasing units of the rewritable non-volatile memory module are logically operated, but actual positions of the physical units of the rewritable non-volatile memory module are not changed.

Referring to FIG. 4, the memory management circuit 202 may logically divide the physical erasing units 304(0) to 304(R) of the rewritable non-volatile memory module 106 into a plurality of areas such as a data area 402, a spare area 404 and a system area 406.

The physical erasing units of the data area 402 are configured to store data from the host system 1000. The spare area 404 includes spare physical erasing units which are configured as a buffer area of the data area 402. For instance, when the host system 1000 intends to update the data in the data area 402, such data is first written into spare physical erasing units in the spare area 404 before being copied to the data area 402 or merged with the data in the data area 402. Or, the physical erasing units in the spare area 404 may also be configured to replace the physical erasing units of the data area 402 and the system area 406. Namely, when the physical erasing units in the data area 402 and the system area 406 are damaged (i.e., becoming bad physical erasing units), the physical erasing units of the spare area 404 may be used to replace the bad physical erasing units. If available physical erasing units are not present in the spare area 404 when the physical erasing units are damaged, the memory storage device 100 is announced by the memory controlling circuit unit 104 as in a write protect status, and the data cannot be written therein. In another exemplary embodiment, the memory management circuit 202 may also combine use of the data area 402 and the spare area 404 together, and the invention is not limited thereto.

The physical erasing units of the system area 406 are configured to record system information including information related to manufacturer and model of a memory chip, a number of physical erasing units in the memory chip, a number of the physical programming unit in each physical erasing unit, and so forth.

The amount of the physical erasing units in the data area 402, the spare area 404 and the system area 406 may be different based on the different memory specifications. In addition, it should be understood that, during the operation of the memory storage device 100, grouping relations of the physical erasing units associated to the data area 402, the spare area 404 and the system area 406 may be dynamically changed. For example, when the damaged physical erasing units in the data area 402 are replaced by the physical erasing units in the spare area 404, the physical erasing units originally from the spare area 404 are associated to the data area 402.

The memory management circuit 202 configures logical addresses 410(0) to 410(D) for mapping the physical erasing units 304(0) to 304(A) in the data area 402. The host system 1000 may access the data in the data area 402 through the logical addresses 410(0) to 410(D). In the present exemplary embodiment, one logical address is mapped to one physical sector, a logical programming unit is constituted by multiple logical addresses, and a logical erasing unit is constituted by multiple logical programming units.

In the present exemplary embodiment, the memory management circuit 202 manages the rewritable non-volatile memory module 106 by the logical programming units, thus one mapping table is established by the memory management circuit 202 for recording a mapping relation between the logical programming units and the physical programming units. In another exemplary embodiment, the memory management circuit 202 manages the rewritable non-volatile memory module 106 by the logical erasing units, thus one mapping table is established by the memory management circuit 202 for recording a mapping relation between the logical erasing units and the physical erasing units.

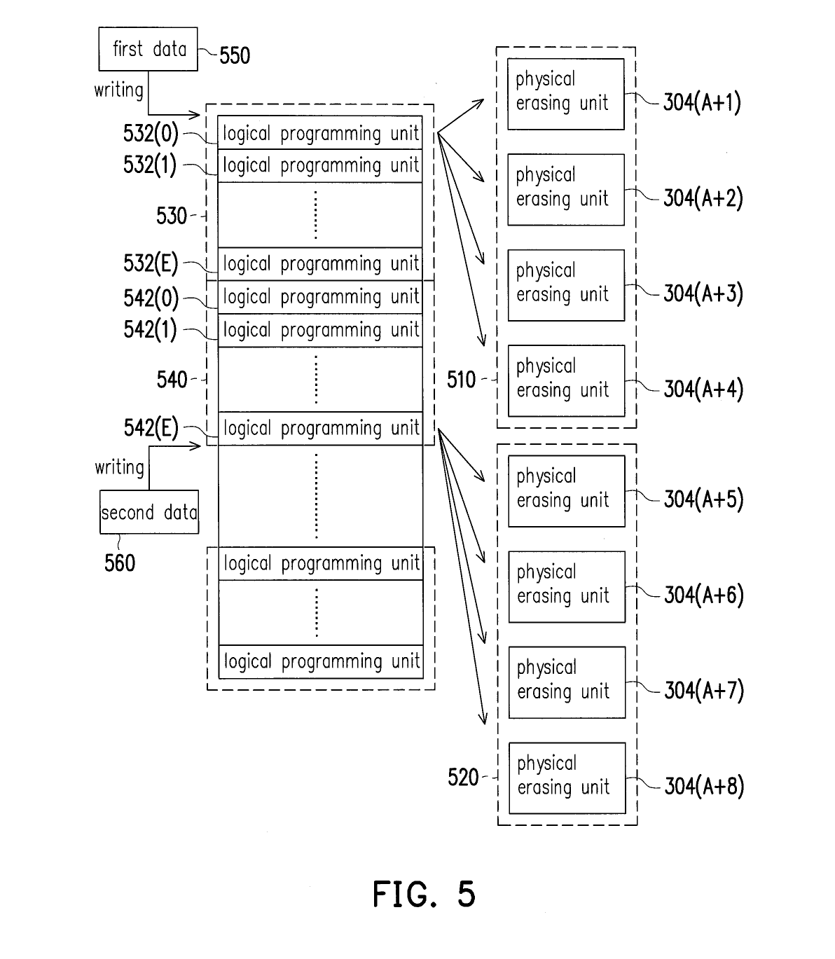

FIG. 5 illustrates a schematic diagram of data writing according to an exemplary embodiment.

In the present exemplary embodiment, a plurality of super physical erasing units are configured in the memory management circuit 202, and each of the super physical erasing units includes at least two physical erasing units. The at least two physical erasing units in the same super physical erasing unit belong to different operation units for being programmed alternately or simultaneously. Referring to FIG. 5, in the exemplary embodiment of FIG. 5, a super physical erasing unit 510 (also known as a first super physical erasing unit) includes physical erasing units 304(A+1) to 304(A+4), and a super physical erasing unit 520 (also known as a second super physical erasing unit) includes physical erasing units 304(A+5) to 304(A+8). The physical erasing unit 304(A+1) (also known as a first physical erasing unit) and the physical erasing unit 304(A+5) (also known as a third physical erasing unit) belong to a first plane of a first chip; the physical erasing unit 304(A+2) (also known as a second physical erasing unit) and the physical erasing unit 304(A+6) (also known as a fifth physical erasing unit) belong to a second plane of the first chip; the physical erasing unit 304(A+3) and the physical erasing unit 304(A+7) belong to a first plane of a second chip; and the physical erasing unit 304(A+4) and the physical erasing unit 304(A+8) belong to a second plane of the second chip. Herein, the first chip or the first plane may also be referred to as a first operation unit, and the second chip or the second plane may also be referred to as a second operation unit. However, in case the memory storage device 100 includes more than two channels, the first operation unit may also be a first channel and the second operation unit may also be a second channel, and the invention is not limited thereto.

One logical erasing unit is mapped to one super physical erasing unit, namely, one logical erasing unit is mapped to a plurality of physical erasing units. In an exemplary embodiment, a product of said positive integers n, m and k is the number of physical erasing units in one super physical erasing unit, namely, the product represents the number of the physical erasing units mapped to one logical erasing unit. In the exemplary embodiment of FIG. 5, the positive integer n is 1, the positive integer m is 2, and the positive integer k is 2. Accordingly, one logical erasing unit is mapped to four different physical erasing units, and one logical programming unit is mapped to one physical programming unit in each of the four different physical erasing units, so as to increase a writing speed thereof. For instance, a logical erasing unit 530 is mapped to the super physical erasing unit 510, and the logical erasing unit 530 includes logical programming units 532(0) to 532(E). In case a capacity of one physical programming unit is 4 KB (kilobyte), a capacity of one logical programming unit is 16 KB. In this case, the host system 100 issues a writing command (also know as a first writing command) which instructs to write first data into the logical programming unit 532(0). It is assumed that a size of the first data is 16 KB, the memory management circuit 202 may divide the first data 550 into four parts (a first part to a fourth part), and a size of each of the four parts is 4 KB. Therein, the logical address (also known as a second logical address) belonging to the second part is arranged after the logical address (also known as a first logical address) belonging to the first part; the logical address belonging to the third part is arranged after the logical address belonging to the second part; and the logical address belonging to the fourth part is arranged after the logical address belonging to the third part. After the first writing command is received, the memory management circuit 202 writes the first part of the first data 550 into the physical erasing unit 304(A+1), and simultaneously write the second part of the first data 550 into the physical erasing unit 304(A+2). Meanwhile, the memory management circuit 202 also simultaneously writes the third part and the fourth part of the first data 550 into the physical erasing unit 304(A+3) and the physical erasing unit 304(A+4), respectively.

In the present exemplary embodiment, if other writing commands are further issued from the host system 1000, the memory management circuit 202 may also write data instructed by said other writing commands into the physical erasing units 304(A+1) to 304(A+4) until there is no spare physical programming unit left in the physical erasing units 304(A+1) to 304(A+4). Subsequently, in case another writing command (also known as a second writing command) which instructs to write second data 560 is received by the memory management circuit 202, the memory management circuit 202 may write the second data 560 into the super physical erasing unit 520. For instance, a logical erasing unit 540 is mapped to the super physical erasing unit 520, and the logical erasing unit 540 includes logical programming units 542(0) to 542(E). The second data 560 is to be written into the logical programming unit 542(E), and a size of the second data 560 is 16 KB. As similar to the first data 550 being divided into the four parts, the memory management circuit 202 may also divide the second data 560 into four parts, and a size of each of the four parts is 4 KB. The memory management circuit 202 may write the first part of the second data 560 into the physical erasing unit 304(A+5), and simultaneously write the second part of the second data 560 into the physical erasing unit 304(A+6). Meanwhile, the memory management circuit 202 may also simultaneously write the third part and the fourth part of the second data 560 into the physical erasing unit 304(A+7) and the physical erasing unit 304(A+8), respectively.

For each plane of each chip, the memory management circuit 202 may establish a spare table for recording the spare physical erasing units in the corresponding plane. When there is no spare physical programming unit left in the physical erasing units 304(A+5) to 304(A+8), the memory management circuit 202 selects one spare physical erasing unit from each plane of each chip (i.e. select a total of four physical erasing units) according to the spare table for writing the data. When the number of spare physical erasing units in the spare area 404 is less than a threshold value, the memory management circuit 202 may execute a garbage collection procedure.

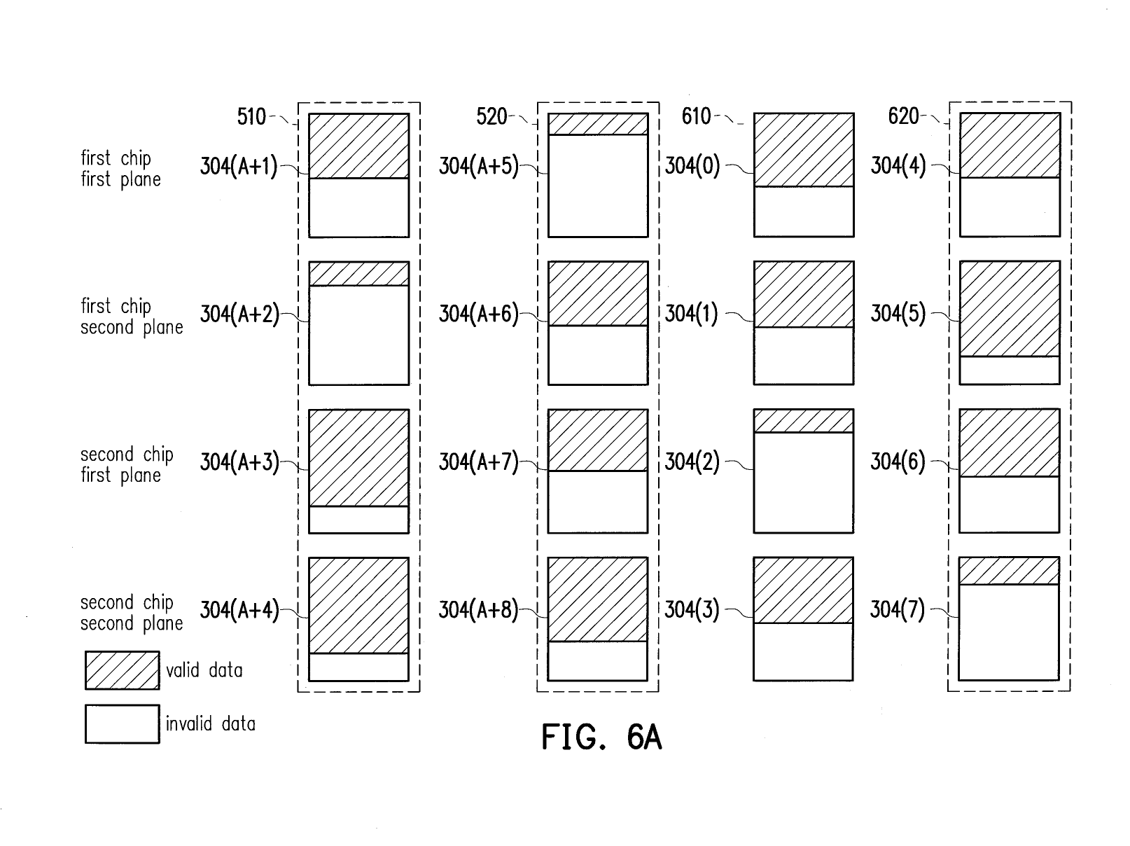

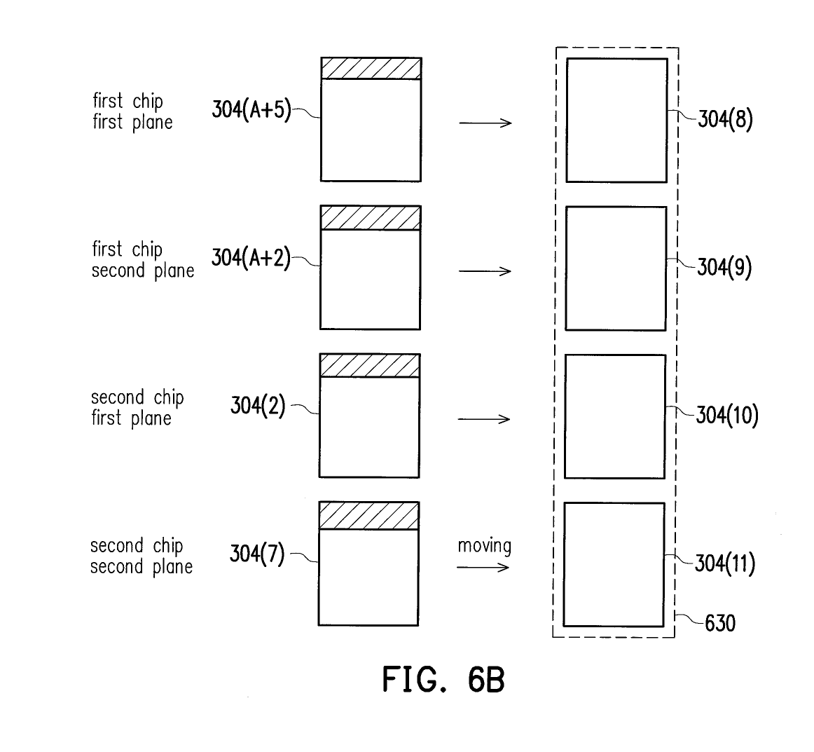

FIG. 6A and FIG. 6B are schematic diagrams illustrating a garbage collection procedure according to an exemplary embodiment.

Referring to FIG. 6A, a super physical erasing unit 610 includes physical erasing units 304(0) to 304(3), and a super physical erasing unit 620 includes physical erasing units 304(4) to 304(7). The physical erasing units 304(0) and 304(4) both belong to a first plane of a first chip. The physical erasing units 304(1) and 304(5) both belong to a second plane of the first chip. The physical erasing units 304(2) and 304(6) both belong to a first plane of a second chip. The physical erasing units 304(3) and 304(7) both belong to a second plane of the second chip. In each of the physical erasing units of FIG. 6A, a slash portion represents valid data, and a blank part represents invalid data. A larger area of the slash portion indicates that more of the valid data are included therein.

The memory management circuit 202 may select one physical erasing unit from each plane, and copy the valid data in such physical erasing unit into another physical erasing unit. In particular, the selected physical erasing units may belong to different super physical erasing units. For instance, the memory management circuit 202 may select the physical erasing unit 304(A+5) from the first plane of the first chip, select the physical erasing unit 304(A+2) from the second plane of the first chip, select the physical erasing unit 304(2) from the first plane of the second chip, and select the physical erasing unit 304(7) from the second plane of the second chip. It should be noted that, the selected physical erasing units 304(A+2), 304(A+5), 304(2) and 304(7) belong to the different super physical erasing units. Referring to FIG. 6B, the memory management circuit 202 may copy the valid data in the selected physical erasing units into at least one physical erasing unit (also known as a fourth physical erasing unit). For instance, the memory management circuit 202 may copy the valid data in the physical erasing units 304(A+2), 304(A+5), 304(2) and 304(7) into the physical erasing unit 304(8) to 304(11) in a super physical erasing unit 630. Further, the memory management circuit 202 erases the selected physical erasing units 304(A+5), 304(A+2), 304(2) and 304(7) so they become the spare physical erasing units. The memory management circuit 202 may also record the erased physical erasing units in the corresponding spare table. It should be noted that, the valid data in one plane may be copied into the physical erasing unit of the same plane, or into the physical erasing unit of a different plane. In other words, the valid data in the physical erasing unit 304(A+5) may be copied into the physical erasing unit 304(8) or the physical erasing unit 304(9) to 304(11), or may be distributed over the physical erasing units 304(8) to 304(11), and the invention is not limited thereto. Further, in the exemplary embodiment of FIG. 6A, the selected physical erasing units belong to the different super physical erasing units. However, in another exemplary embodiment, the selected physical erasing units may also belong to the same super physical erasing unit, and the invention is not limited thereto.

In an exemplary embodiment, the physical erasing unit 304(A+5) is the physical erasing unit storing least valid data among the physical erasing units belonging to the first plane of the first chip and storing the valid data. For instance, the physical erasing unit 304(A+5) stores less of the valid data in comparison to that of the physical erasing units 304(A+1), 304(0) and 304(4). In addition, the physical erasing unit 304(A+2) is the physical erasing unit storing least valid data among the physical erasing units belonging to the second plane of the first chip and storing the valid data. Similarly, the physical erasing units 304(2) and 304(7) are also the physical erasing units storing least valid data in the corresponding plane. Accordingly, less of the valid data is copied by the memory management circuit 202 when the garbage collection procedure is executed.

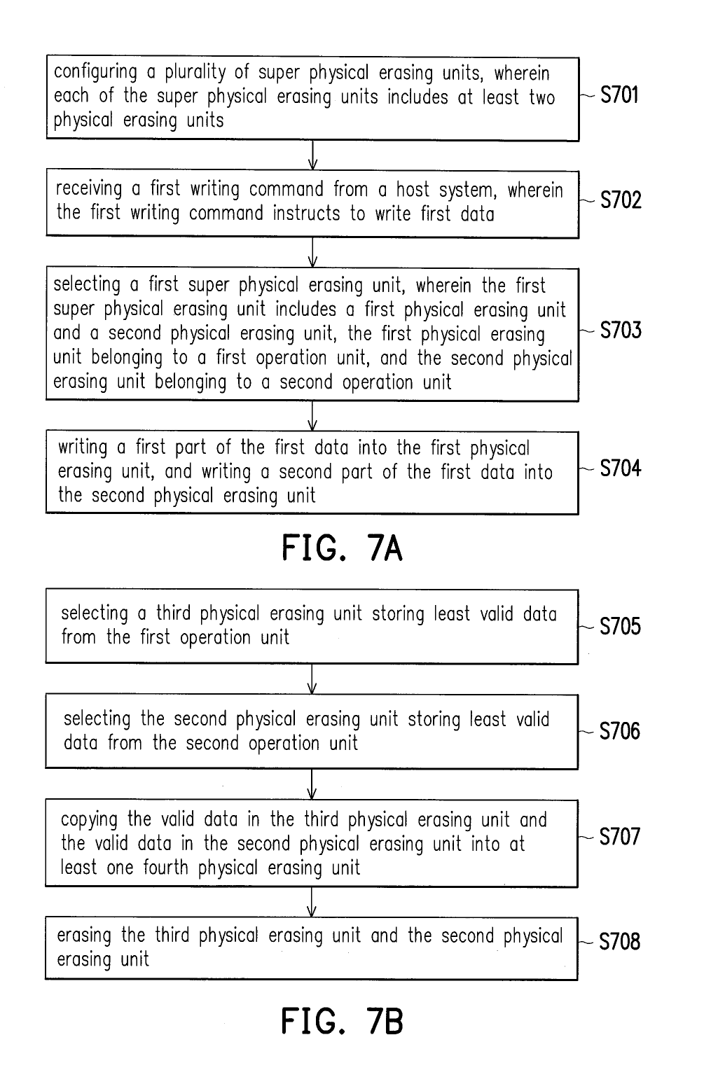

FIG. 7A and FIG. 7B are a flowchart illustrating a memory management method according to an exemplary embodiment.

Referring to FIG. 7A, in step S701, a plurality of super physical erasing units are configured, and each of the super physical erasing units includes at least two physical erasing units. In step S702, a first writing command is received from a host system, and the first writing command instructs to write first data. In step S703, a first super physical erasing unit is selected, in which the first super physical erasing unit includes a first physical erasing unit and a second physical erasing unit, the first physical erasing unit belonging to a first operation unit, and the second physical erasing unit belonging to a second operation unit. In step S704, a first part of the first data is written into the first physical erasing unit, and a second part of the first data is written into the second physical erasing unit.

Referring to FIG. 7B, in step S705, a third physical erasing unit storing least valid data is selected from the first operation unit. In step S706, the second physical erasing unit storing least valid data is selected from the second operation unit. In step S707, the valid data in the third physical erasing unit and the valid data in the second physical erasing unit is copied into at least one fourth physical erasing unit. In step S708, the third physical erasing unit and the second physical erasing unit are erased.

Steps S705 to S708 may also be referred to as the garbage collection procedure. Nevertheless, steps depicted in FIG. 7A and FIG. 7B have been described in detail as above, thus related description thereof is omitted hereinafter. It should be noted that, the steps depicted in FIG. 7A and FIG. 7B may be implemented as a plurality of program codes or circuits. However, the invention is not limited thereto. Moreover, the method disclosed in FIG. 7A and FIG. 7B may be implemented with reference to above embodiments, or may be implemented separately, and the invention is not limited thereto.

### Second Exemplary Embodiment

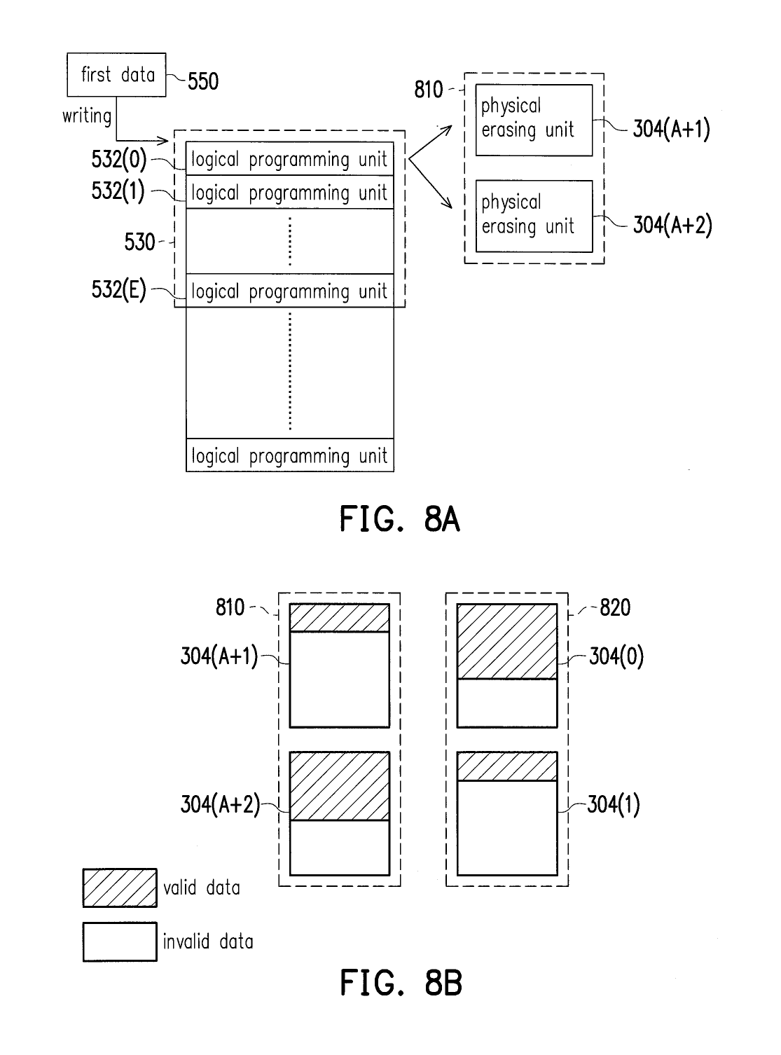

FIG. 8A illustrates a schematic diagram illustrating a super physical erasing unit according to an exemplary embodiment.

Hereinafter, only differences between second exemplary embodiment and first exemplary embodiment are described below. In second exemplary embodiment, the memory storage device 100 includes two channels, in which each channel is connected to one chip, and each chip only includes one plane. Referring to FIG. 8A, a super physical erasing unit 810 includes the physical erasing units 304(A+1) and 304(A+2), in which the physical erasing unit 304(A+1) belongs to a first channel, and the physical erasing unit 304(A+2) belongs to a second channel. In other words, the physical erasing units in the super physical erasing unit 810 belong to different operation units (channels). After a writing command is issued by the host system 100 to write the first data 550 into the logical programming unit 532(0), the memory management circuit 202 may write the first part of the first data 550 into the physical erasing unit 304(A+1), and simultaneously write the second part of the first data 550 into the physical erasing unit 304(A+2). When a number of the spare physical erasing units in the first channel and the second channel is less than a threshold value, the memory management circuit 202 may execute a garbage collection procedure.

FIG. 8B is schematic diagram illustrating a garbage collection procedure according to an exemplary embodiment.

Referring to FIG. 8B, a super physical erasing unit 820 includes the physical erasing unit 304(0) and the physical erasing unit 304(1), and the super physical erasing unit 810 includes the physical erasing unit 304(A+1) and the physical erasing unit 304(A+2), in which the physical erasing unit 304(0) and the physical erasing unit 304(A+1) belong to the first channel, and the physical erasing unit 304(1) and the physical erasing unit 304(A+2) belongs to the second channel. The memory management circuit 202 may select the physical erasing unit storing least valid data from the first channel, and select the physical erasing unit storing least valid data from the second channel, for executing the garbage collection procedure. For instance, the physical erasing unit 304(A+1) and the physical erasing unit 304(1) are selected by the memory management circuit 202. The memory management circuit 202 may copy the valid data in the selected physical erasing units into other physical erasing units, and then erase the selected physical erasing units.

### Third Exemplary Embodiment

Hereinafter, only differences between third exemplary embodiment and second exemplary embodiment are described below. In third exemplary embodiment, the memory storage device 100 includes one channel, in which the channel is connected to two chips, and each of the two chips includes one plane. Referring still to FIG. 8A, unlike the foregoing embodiment, the physical erasing unit 304(A+1) belongs to the first chip and the physical erasing unit 304(A+2) belongs to the second chip, and the first chip and the second chip belong to the same channel. After the first data 550 is received, the memory management circuit 202 may write the first part of the first data 550 into the physical erasing unit 304(A+1). Simultaneously, the memory management circuit 202 may write the second part of the first data 550 into the physical erasing unit 304(A+2), even before the ready signal is replied from the first chip.

Referring to FIG. 8B, in third exemplary embodiment, the physical erasing unit 304(0) belongs to the first chip, and the physical erasing unit 304(1) belongs to the second chip. The memory management circuit 202 may select the physical erasing units storing least valid data respectively from the first chip and the second chip, copy the valid data therein into other physical erasing units, and then erase the selected physical erasing units. Nevertheless, steps of the garbage collection procedure depicted in FIG. 5 have been described as above, thus related description is omitted hereinafter.

### Fourth Exemplary Embodiment

Hereinafter, only differences between fourth exemplary embodiment and second exemplary embodiment are described below. In third exemplary embodiment, the memory storage device 100 includes one channel, in which the channel is connected to one chip, and the chip include two planes. Referring still to FIG. 8A, unlike the foregoing embodiment, the physical erasing unit 304(A+1) belongs to the first plane and the physical erasing unit 304(A+2) belongs to the second plane, and the first plane and the second plane belong to the same chip. After the first data 550 is received, the memory management circuit 202 may transmit the first part and the second part of the first data 550 to the buffer area in the rewritable non-volatile memory module 106. The memory management circuit 202 may transmit a writing signal to the rewritable non-volatile memory module 106, so that the rewritable non-volatile memory module 106 may write the first part of the first data 550 into the physical erasing unit 304(A+1) and simultaneously write the second part into the physical erasing unit 304(A+2).

Referring to FIG. 8B, in fourth exemplary embodiment, the physical erasing unit 304(0) belongs to the first plane, and the physical erasing unit 304(1) belongs to the second plane. The memory management circuit 202 may select the physical erasing units storing least valid data respectively from the first plane and the second plane, copy the valid data therein into other physical erasing units, and then erase the selected physical erasing units. Nevertheless, steps of the garbage collection procedure depicted in FIG. 5 have been described as above, thus related description is omitted hereinafter.

In view of above, the memory management method, the memory controlling circuit unit and the memory storage device as proposed according to the exemplary embodiments of the invention are capable of selecting the physical erasing unit storing least valid data from each operation unit for executing the garbage collection procedure, such that the valid data to be copied and re-programmed may be reduced. Accordingly, a time required for the garbage collection procedure may be shorter or a write amplification may be reduced.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A memory management method for a rewritable non-volatile memory module, wherein the rewritable non-volatile memory module comprises a plurality of physical erasing units, each of the physical erasing units belongs to one of a plurality of operation units, and the memory management method comprises:
configuring a plurality of super physical erasing units, wherein each of the super physical erasing units comprises at least two of the physical erasing units, wherein the super physical erasing units comprises a first super physical erasing unit, the first super physical erasing unit comprises a first physical erasing unit and a second physical erasing unit among the physical erasing units, the first physical erasing unit belongs to a first operation unit among the operation units, the second physical erasing unit belongs to a second operation unit among the operation units, a first part of first data is stored in the first physical erasing unit, and a second part of the first data is stored in the second physical erasing unit;
selecting, from among the physical erasing units storing valid data in the first operation unit, a third physical erasing unit storing least valid data;
selecting the second physical erasing unit from the second operation unit;
copying the valid data in the third physical erasing unit and valid data in the second physical erasing unit into at least one fourth physical erasing unit among the physical erasing units; and
erasing the third physical erasing unit and the second physical erasing unit.

2. The memory management method of claim 1, wherein the third physical erasing unit belongs to a second super physical erasing unit among the super physical erasing units, and the second super physical erasing unit is different from the first super physical erasing unit.

3. The memory management method of claim 1, wherein the physical erasing units in each of the super physical erasing units belong to different operation units.

4. The memory management method of claim 1, wherein each of the operation units is a channel, a chip or a plane.

5. The memory management method of claim 1, further comprising:
configuring a plurality of logical addresses, wherein the first part of the first data belongs to at least one first logical address among the logical addresses, the second part of the first data belongs to at least one second logical address among the logical addresses, and the second logical address is arranged after the first logical address.

6. The memory management method of claim 5, wherein the logical addresses constitute a plurality of logical programming units, the logical programming units constitute a plurality of logical erasing units, and the first super physical erasing unit is mapped to at least one of the logical erasing units.

7. The memory management method of claim 1, wherein the second physical erasing unit is, among the physical erasing units storing valid data in the second operation unit, the physical erasing unit storing least valid data.

8. A memory storage device, comprising:
a connection interface unit configured to couple to a host system;
a rewritable non-volatile memory module having a plurality of physical erasing units, wherein each of the physical erasing units belongs to one of a plurality of operation units; and
a memory controlling circuit unit coupled to the connection interface unit and the rewritable non-volatile memory module, and configured to configure a plurality of super physical erasing units, wherein each of the super physical erasing units comprises at least two of the physical erasing units, the super physical erasing units comprises a first super physical erasing unit, the first super physical erasing unit comprises a first physical erasing unit and a second physical erasing unit among the physical erasing units, the first physical erasing unit belongs to a first operation unit among the operation units, the second physical erasing unit belongs to a second operation unit among the operation units, a first part of first data is stored in the first physical erasing unit, and a second part of the first data is stored in the second physical erasing unit,
wherein the memory controlling circuit unit is configured to select, from among the physical erasing units storing valid data in the first operation unit, a third physical erasing unit storing least valid data, and select the second physical erasing unit from the second operation unit,
wherein the memory controlling circuit unit is configured to copy the valid data in the third physical erasing unit and valid data in the second physical erasing unit into at least one fourth physical erasing unit among the physical erasing units, and erase the third physical erasing unit and the second physical erasing unit.

9. The memory storage device of claim 8, wherein the third physical erasing unit belongs to a second super physical erasing unit among the super physical erasing units, and the second super physical erasing unit is different from the first super physical erasing unit.

10. The memory storage device of claim 9, wherein the physical erasing units in each of the super physical erasing units belong to different operation units.

11. The memory storage device of claim 8, wherein each of the operation units is a channel, a chip or a plane.

12. The memory storage device of claim 8,
wherein the memory controlling circuit unit is further configured to configure a plurality of logical addresses, wherein the first part of the first data belongs to at least one first logical address among the logical addresses, the second part of the first data belongs to at least one second logical address among the logical addresses, and the second logical address is arranged after the first logical address.

13. The memory storage device of claim 12, wherein the logical addresses constitute a plurality of logical programming units, the logical programming units constitute a plurality of logical erasing units, and the first super physical erasing unit is mapped to at least one of the logical erasing units.

14. The memory storage device of claim 8, wherein the second physical erasing unit is, among the physical erasing units storing valid data in the second operation unit, the physical erasing unit storing least valid data.

15. A memory controlling circuit unit for controlling a rewritable non-volatile memory module, wherein the rewritable non-volatile memory module comprises a plurality of physical erasing units, each of the physical erasing units belongs to one of a plurality of operation units, and the memory controlling circuit unit comprises:
a host interface configured to couple to a host system;
a memory interface configured to couple to the rewritable non-volatile memory module; and
a memory management circuit coupled to the host interface and the memory interface, and configured to configure a plurality of super physical erasing units, wherein each of the super physical erasing units comprises at least two of the physical erasing units, the super physical erasing units comprises a first super physical erasing unit, the first super physical erasing unit comprises a first physical erasing unit and a second physical erasing unit among the physical erasing units, the first physical erasing unit belongs to a first operation unit among the operation units, the second physical erasing unit belongs to a second operation unit among the operation units, a first part of first data is stored in the first physical erasing unit, and a second part of the first data is stored in the second physical erasing unit,
wherein the memory management circuit is configured to select, from among the physical erasing units storing valid data in the first operation unit, a third physical erasing unit storing least valid data, and select the second physical erasing unit from the second operation unit,
wherein the memory management circuit is configured to copy the valid data in the third physical erasing unit and valid data in the second physical erasing unit into at least one fourth physical erasing unit among the physical erasing units, and erase the third physical erasing unit and the second physical erasing unit.

16. The memory controlling circuit unit of claim 15, wherein the third physical erasing unit belongs to a second super physical erasing unit among the super physical erasing units, and the second super physical erasing unit is different from the first super physical erasing unit.

17. The memory controlling circuit unit of claim 16, wherein the physical erasing units in each of the super physical erasing units belongs to different operation units.

18. The memory controlling circuit unit of claim 15, wherein each of the operation units is a channel, a chip or a plane.

19. The memory controlling circuit unit of claim 15,
wherein the memory management circuit is further configured to configure a plurality of logical addresses, wherein the first part of the first data belongs to at least one first logical address among the logical addresses, the second part of the first data belongs to at least one second logical address among the logical addresses, and the second logical address is arranged after the first logical address.

20. The memory controlling circuit unit of claim 19, wherein the logical addresses constitute a plurality of logical programming units, the logical programming units constitute a plurality of logical erasing units, and the first super physical erasing unit is mapped to at least one of the logical erasing units.

21. The memory controlling circuit unit of claim 15, wherein the second physical erasing unit is, among the physical erasing units storing valid data in the second operation unit, the physical erasing unit storing least valid data.
